(19) United States
(12) Patent Application Publication
(10) Pub. No.: US 2012/0321215 A1
(43) Pub. Date: Dec. 20, 2012

(54) METHOD FOR TUNING IMAGE QUALITY AND SYSTEM USING THE SAME

(75) Inventor: Shih-Sen Hsieh, New Taipei City (TW)

(73) Assignees: Kinpo Electronics, Inc., New Taipei City (TW); Cal-Comp Electronics & Communications Company Limited, New Taipei City (TW)

(21) Appl. No.: 13/207,437

(22) Filed: Aug. 11, 2011

(30) Foreign Application Priority Data
Jun. 16, 2011 (TW) 100121052

(51) Int. Cl. G06K 9/40

(52) U.S. Cl. 382/274; 382/254

(57) ABSTRACT

A method for tuning image quality and a system using the same are provided. The method is adapted for tuning image quality parameters of at least one image processing device, and includes following steps. After firmware of the image processing apparatuses are compiled and burned into the image processing devices, at least an image processing function along with their respective image processing parameters are configured to each of the image processing devices. An image processing process including at least one image tuning procedure is executed. In addition, when executing each one of the image tuning procedures, it is to select to upload a predetermined image to a first predetermined image processing procedure location of the currently executed image tuning procedure, or select to download another image from a second predetermined image processing procedure location of the currently executed image tuning procedure.

### CROSS-REFERENCE TO RELATED APPLICATION

This application claims the priority benefit of Taiwan application serial no. 100121052, filed on Jun. 16, 2011. The entirety of the above-mentioned patent application is hereby incorporated by reference herein and made a part of specification.

### BACKGROUND

1. Field of the Invention

The invention relates to a method for tuning image quality, and particularly, the invention relates to a method for tuning image quality capable of simultaneously tuning image quality parameters of a plurality of image processing devices, and a system using the same method.

2. Description of Related Art

During an image quality tuning process of an all-in-one (AIO) machine, a large amount of testing is required to be executed on effects presented by different image parameters corresponding to each of the functions, so that it is required to continuously modify a firmware program, and make/compile the firmware and build/burn the firmware into the AIO machine. FIG. 1A and FIG. 1B are flowcharts illustrating a scan job of an AIO machine.

Referring to FIG. 1A, firstly, a program designer modifies program codes of the AIO machine to determine whether an image processing function is enabled or not, and sets quality parameters thereof to adjust an image output result (step 101). Then, after the program modification, the firmware has to be compiled to confirm whether the syntax of the modified program is correct and perform format conversion (step 102). Further, a burning procedure is performed to load the program codes into the AIO machine (step 103).

After the scan job is started, a scanner captures the scanned document, and converts the scanned image data into digital data (step 104). Then, it is determined whether a shading correction procedure is required to be executed (step 105), and if not, the flow continues to execute a next processing procedure (from a node B to a step 107). The shading correction procedure is one of image processing techniques, which is used for compensating a shadow or uneven brightness caused by a light source to even the brightness (from the node B to the step 106). Next, it is determined whether a gamma correction procedure is required to be executed (the step 107), and if not, the flow continues to execute a next processing procedure (step 109). The gamma correction procedure is one of image processing techniques, and the correction is performed according to a correction curve of the gamma correction procedure to achieve a linear output effect (step 108). After each image processing function is ended, the digital image data processing is completed, and it is determined whether a required image quality effect is achieved according to the output image (step 109). If the output effect is not satisfactory, the image quality parameters of each of the image processing functions are adjusted again (from a node A to the step 101). Conversely, the image quality tuning process is terminated.

However, during the process for tuning image quality, each time of adjusting the image quality parameters, the program codes are required to be modified, and the firmware is compiled and burned to the device, which may consume a rather long time. Moreover, after the AIO machine is activated, debugging of the image correction can only be determined by printing program execution information or a final output result, and data variation during the image processing process cannot be obtained, which is obviously lack of flexibility in debugging. Moreover, each of the AIO machines has deviations, but the image quality tuning process can only adjust the image quality parameters of a single machine. If it is required to obtain the image quality parameters of a plurality of the AIO machines, the consumed time is increased by several times. Therefore, how to adjust the image quality tuning method of the image processing device to improve the efficiency of the image quality tuning process is an important issue of the industry.

### SUMMARY

Accordingly, exemplary embodiments of the invention provide a method and an image quality tuning system capable of simultaneously tuning image quality parameters of a plurality of image processing devices. By connecting one or multiple image processing devices through a network or data cables, and after compiling firmware and burning the firmware into the image processing devices, one or a plurality of image quality tuning parameters are obtained or set, which can greatly improve efficiency and flexibility of the image quality tuning process.

An exemplary embodiment of the invention provides a method for tuning image quality, which is adapted for tuning image quality parameters of at least one image processing device, and the method for tuning image quality includes following steps: (a) executing a compiling procedure of firmware of the at least one image processing device; (b) executing a burning procedure of the firmware of the at least one image processing device; (c) configuring at least one image processing function to each of the image processing devices after the step (a) and the step (b) are executed, and respectively setting image quality parameters of each of the image processing functions; (d) executing an image processing process, where the image processing process includes at least one image tuning procedure; and (e) when each one of the image tuning procedures is executed, selecting to upload a predetermined image to a first predetermined image processing procedure location of the currently executed image tuning procedure, or selecting to download an image from a second predetermined image processing procedure location of the currently executed image tuning procedure.

In an exemplary embodiment of the invention, the step of respectively configuring the at least one image processing function includes respectively enabling or disabling each of the image processing functions.

In an exemplary embodiment of the invention, the step of respectively setting the image quality parameters of each of the image processing functions includes respectively setting or acquiring the image quality parameters of each of the image processing functions.

In an exemplary embodiment of the invention, the step of executing the image processing process includes executing a scan job, a printing job, a digital video capturing job, a digital camera job and a projecting job.

In an exemplary embodiment of the invention, the at least one image tuning procedure includes a shading correction procedure and a gamma correction procedure.

In an exemplary embodiment of the invention, the step of selecting to upload the predetermined image to the first predetermined image processing procedure location of the currently executed image tuning procedure includes uploading the predetermined image to the first predetermined image processing procedure location of the currently executed image tuning procedure to replace an image.

In an exemplary embodiment of the invention, the at least one image processing device includes a scanner, a printer, a digital camera and a projector.

In an exemplary embodiment of the invention, the method further includes continually executing the image processing process after uploading the predetermined image to the first predetermined image processing procedure location of the currently executed image tuning procedure to replace the image.

In an exemplary embodiment of the invention, before the step (a), the method further includes respectively connecting the image processing devices through a network or a data cable.

In an exemplary embodiment of the invention, after respectively executing the step (a) and the step (b) to the connected image processing devices for just one time, the step (c), the step (d) and the step (e) are respectively executed to the connected image processing devices for at least one time.

An exemplary embodiment of the invention provides a image quality tuning system, which includes an image processing device and an electronic device. The image processing device is configured for executing an image processing process, and the image processing device includes a server sub-system and an image processing sub-system, where the image processing sub-system is configured for executing the image processing process, and a step of executing the image processing process includes executing at least one image tuning procedure. The electronic device is configured to execute a compiling procedure and a burning procedure of firmware of the image processing device. Moreover, the electronic device is connected to the server sub-system, and after the electronic device executes the compiling procedure and the burning procedure for once, it performs the following steps: (a) configuring at least one image processing function to the image processing device for at least one time; (b) respectively setting image quality parameters of each of the image processing functions and executing at least one image tuning procedure; and (c) when each one of the image tuning procedures is executed, selecting to upload a predetermined image to a first predetermined image processing procedure location of the currently executed image tuning procedure, or selecting to download an image from a second predetermined image processing procedure location of the currently executed image tuning procedure.

Several embodiments accompanied with figures are described in detail below to further describe the invention in details.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are flowcharts illustrating a scan job of an all-in-one (AIO) machine.

FIG. 2 is a schematic diagram illustrating an image quality tuning system according to an exemplary embodiment of the invention.

FIG. 3 is a functional block diagram of an image processing device according to an exemplary embodiment of the invention.

FIG. 4A and FIG. 4B are flowcharts illustrating a method for tuning image quality according to an exemplary embodiment of the invention.

FIG. 4C is a flowchart illustrating a method for tuning image quality according to another exemplary embodiment of the invention.

FIG. 5 is a flowchart illustrating a transmission flow of an acquiring/replacing quality parameter command according to an exemplary embodiment of the invention.

FIG. 6 is a flowchart illustrating a transmission flow of an enable/disable process command according to an exemplary embodiment of the invention.

FIG. 7 is a flowchart illustrating a transmission flow of an upload tuning image command according to an exemplary embodiment of the invention.

FIG. 8 is a flowchart illustrating a transmission flow of a download image command according to an exemplary embodiment of the invention.

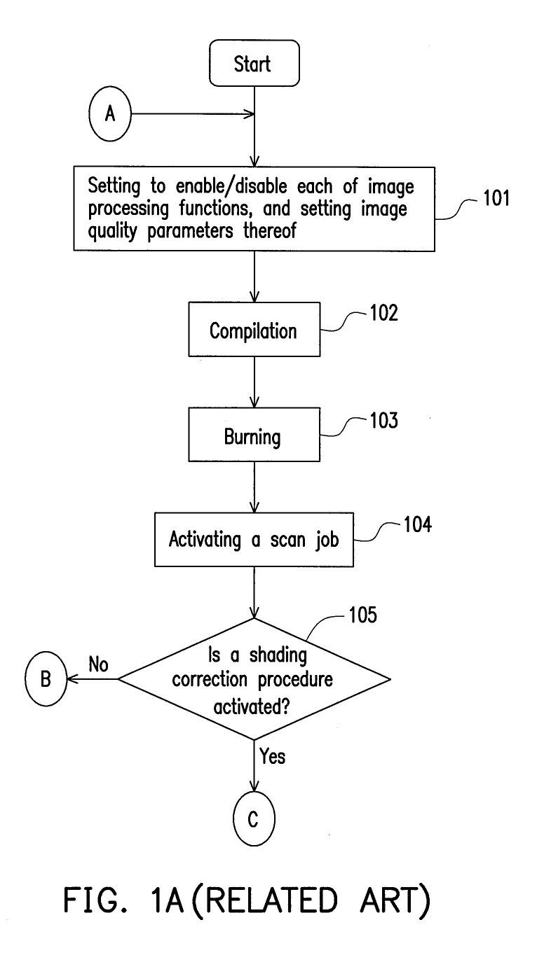

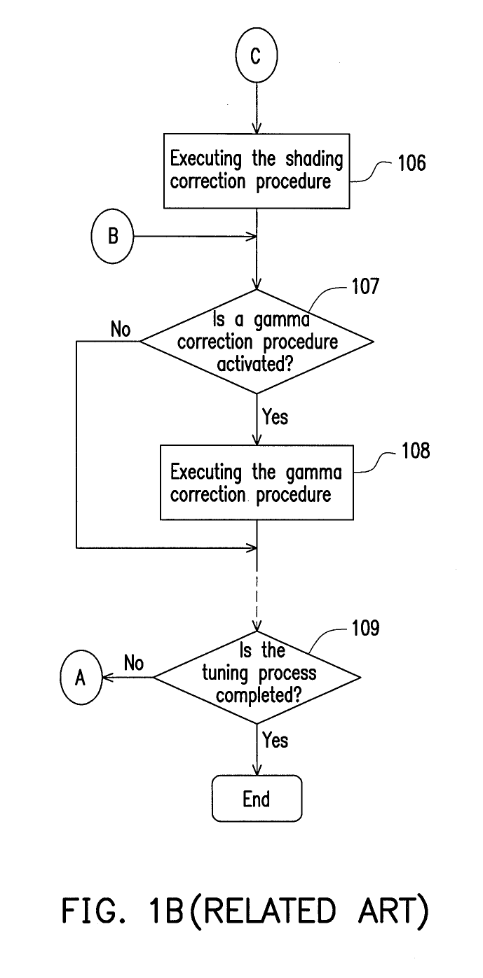

### DETAILED DESCRIPTION OF DISCLOSED EMBODIMENTS

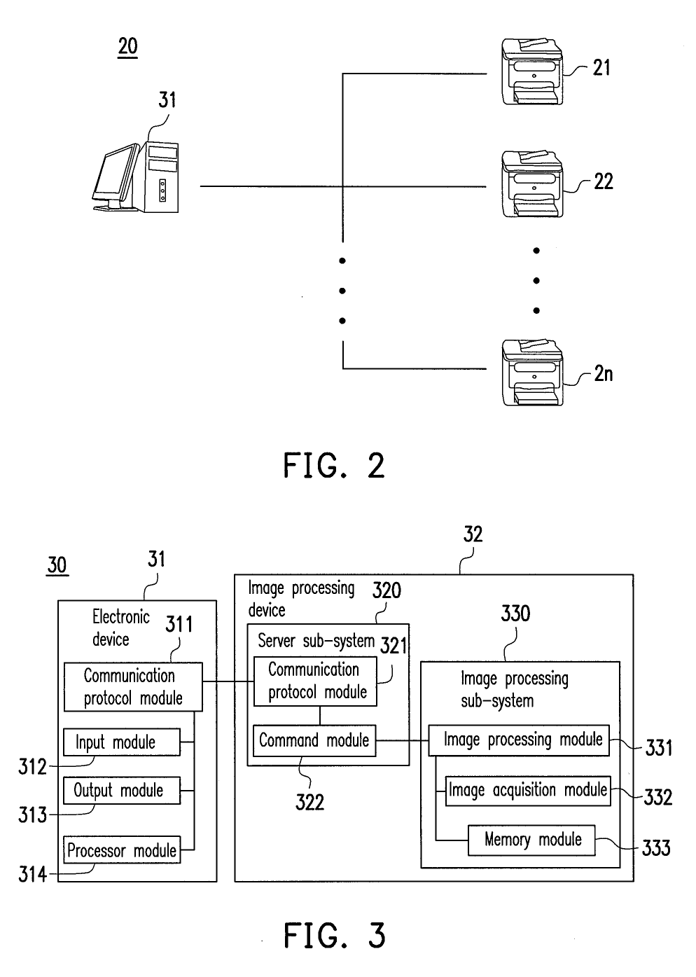

FIG. 2 is a schematic diagram of an image quality tuning system according to an exemplary embodiment of the invention. Referring to FIG. 2, the image quality tuning system includes an electronic device 31, which is connected to one or a plurality of image processing devices 21, 22, . . . , 2n through a network or a data cable. For example, the network can be a local area network or the Internet, and the data cable can be a universal serial bus (USB) data cable. A test operator or a program designer that tunes image quality parameters uses the electronic device 31 to execute a compiling procedure and a burning procedure of firmware of the image processing device. Moreover, the electronic device 31 can be used to burn the firmware to each of the image processing devices through the established connections, and configure an image processing function to each of the image processing devices, and acquire or set image quality parameters of each of the image processing functions. Moreover, the test operator or the program designer that tunes the image quality parameters can further use the electronic device 31 to select to upload a predetermined image to a first predetermined image processing procedure location of a currently executed image tuning procedure, or select to download an image from a second predetermined image processing procedure location of the currently executed image tuning procedure.

FIG. 3 is a functional block diagram of an image processing device according to an exemplary embodiment of the invention. The image processing device 32 can be a scanner, a printer, a digital camera, a projector or an all-in-one (AIO) machine. The electronic device 31 is connected to the image processing device 32 through a network or a data cable to burn the firmware to the image processing device 32, configure the image processing function on the image processing device 32, acquire or set the image quality parameters of each of the image processing functions, upload a predetermined image to the image processing device 32 or download an image from the image processing device 32.

Referring to FIG. 3, the image quality tuning system 30 includes the electronic device 31 and the image processing device 32. The electronic device 31 includes a communication protocol module 311, an input module 312, an output module 313 and a processor module 314. The communication protocol module 311 is configured for connecting the image processing device 32. The input module 312 is connected to the communication protocol module 311 and the output module 313 for receiving images, image quality parameters and commands input by an operator or a program designer that executes the image quality parameter tuning process. The output module 313 is configured for presenting an image downloaded from the image processing device 32. The electronic device 31 can be a computer. Moreover, the processor module 314 is configured for compiling the firmware and burning the firmware into the image processing device 32.

The image processing device 32 is configured for executing an image processing process, and the image processing device 32 includes a server sub-system 320 and an image processing sub-system 330. The image processing sub-system 330 is configured for executing the image processing process, which includes executing one or a plurality of image tuning procedures.

The server sub-system 320 includes a communication protocol module 321 and a command module 322. The communication protocol module 311 of the electronic device 31 is connected to the communication protocol module 321 of the server sub-system 320 through a network or a data cable, and after the electronic device 31 executes the compiling procedure and the burning procedure for once, it performs the following steps: (a) configuring one or a plurality of image processing functions to the image processing device 32 for at least one time; (b) respectively setting image quality parameters of each of the image processing functions and executing one or a plurality of image tuning procedures; and (c) when each one of the image tuning procedures is executed, selecting to upload a predetermined image to a first predetermined image processing procedure location of the currently executed image tuning procedure, or selecting to download an image from a second predetermined image processing procedure location of the currently executed image tuning procedure. The first predetermined image processing procedure location is, for example, a processing procedure location where the image tuning procedure is completed by 50%. The second predetermined image processing procedure location is, for example, a processing procedure location where the other image tuning procedure is completed by 80%.

The command module 322 is connected to the communication protocol module 311, and is configured for receiving the command and the corresponding image quality parameters provided by the electronic device 31, and analyzing the command and transmitting the command and the image quality parameters to the image processing sub-system 330 for execution. Moreover, the command module 322 further receives responses from the image processing sub-system 330 after the image processing sub-system 330 executes various commands, and provides acknowledgement to the electronic device 31, or provides an image to the electronic device 31, where the image is downloaded when the image processing sub-system 330 executes an image tuning procedure.

The image processing sub-system 330 includes an image processing module 331, an image obtaining module 332 and a memory module 333. The image processing module 331 is connected to the command module 322 for receiving the command and the corresponding image quality parameters, and executing a scan job, a printing job, a digital video capturing job, a digital camera job or a projecting job. Moreover, the image processing module 331 further enables and disables various image processing functions according to commands, or replaces, sets or acquires the image quality parameters of various image processing functions.

The image obtaining module 332 is connected to the image processing module 331 and the memory module 333 for downloading an image from a designated image processing procedure location of the image tuning procedure currently executed by the image processing module 331. The memory module 333 is configured for storing a predetermined image uploaded to another designated image processing procedure location by the electronic device 31 that is configured for replacing the image of the designated image processing procedure location.

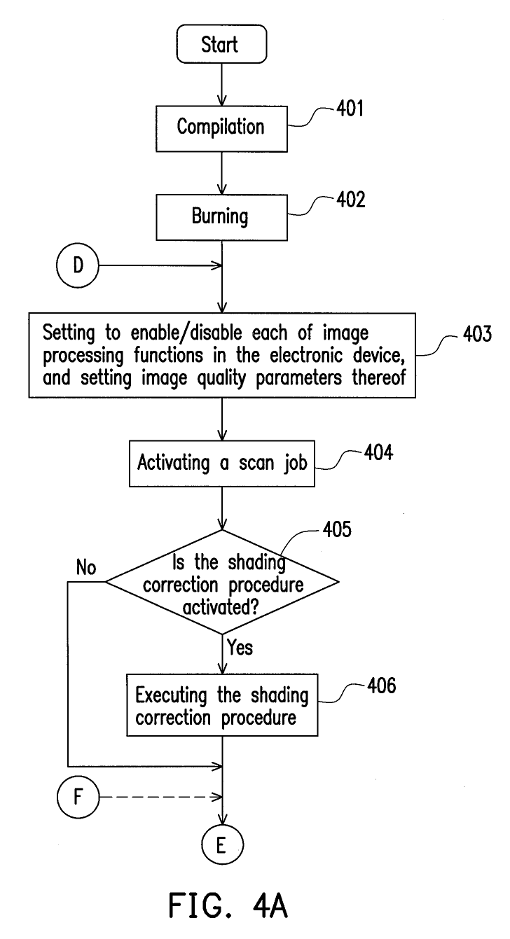

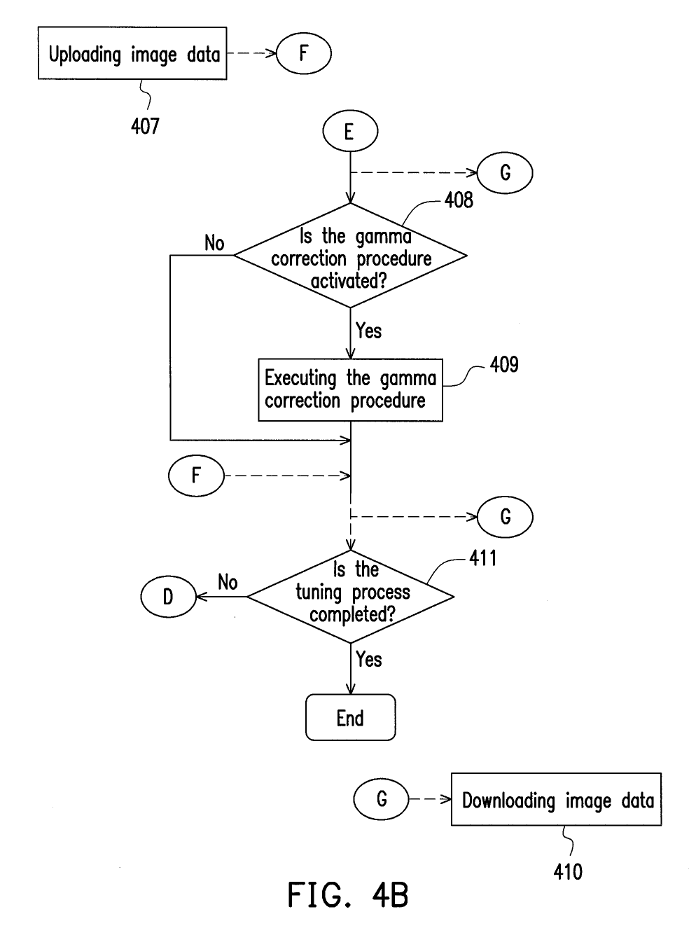

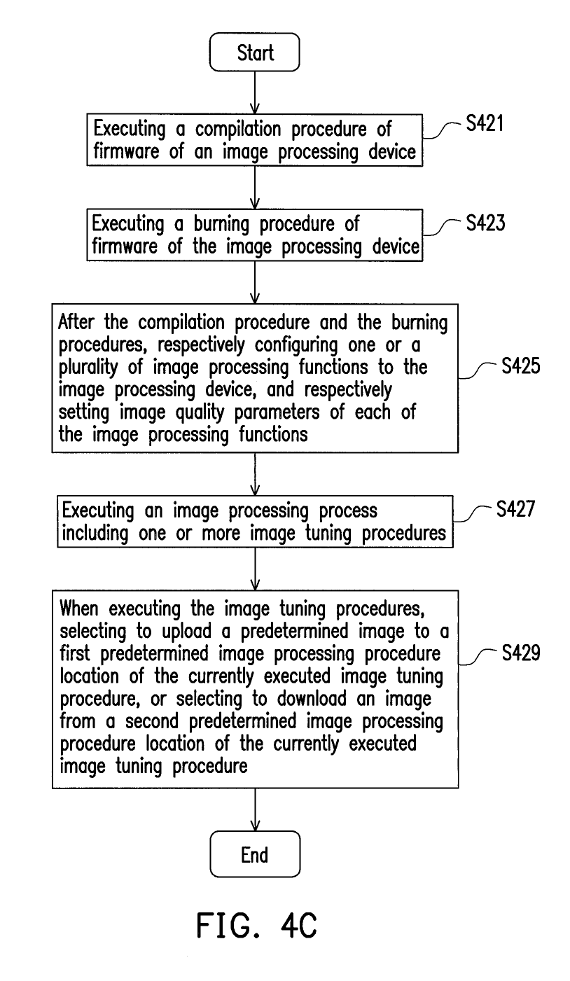

FIG. 4A and FIG. 4B are flowcharts illustrating a method for tuning image quality according to an exemplary embodiment of the invention. The method for tuning image quality is described below in accordance with FIG. 3, FIG. 4A and FIG. 4B. Referring to FIG. 3, FIG. 4A and FIG. 4B, a scanning function of an AIO machine is taken as an example for description. Firstly, after modification of the firmware program of the image processing device 32 is completed, a compiling procedure of the firmware has to be performed to confirm whether the syntax of the modified program is correct and then perform format conversion (step 401). Then, after the burning procedure of the firmware is executed through the server sub-system 320, the program codes can be loaded into the image processing device 32 (step 402). In the present embodiment, before the step 401, the electronic device 31 can be connected to the image processing device 32 through a network or a data cable, so as to burn the firmware to the image processing device 32 through the network or the data cable.

After the burning procedure of the firmware is completed, the image processing device 32 is reset, and the electronic device 31 can transmit a parameter command to the image processing device 32 through the USB data cable or the network (step 403). To be illustrated more clearly, the test operator or the program designer can determine whether or not to activate the image processing functions through the electronic device 31, and set the image quality parameters of each of the image processing functions.

In the present embodiment, in a design of a communication interface between the electronic device 31 and the image processing device 32, a client end is located at the electronic device 31, and the server sub-system 320 (which is a server end or a server) and the image processing sub-system 330 (which is a device end or a device) are located at a firmware end of the image processing device 32.

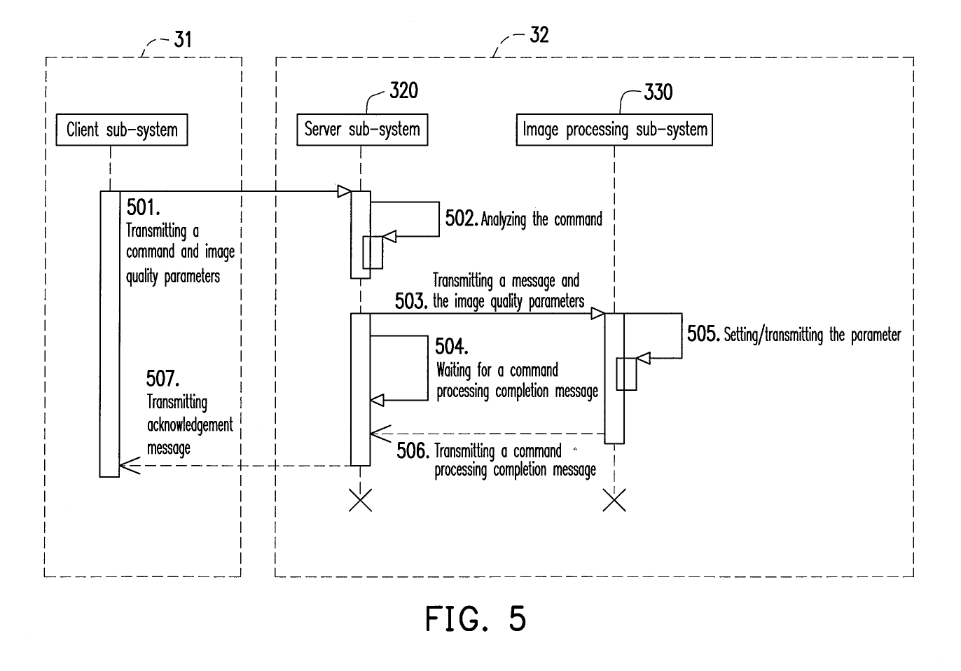

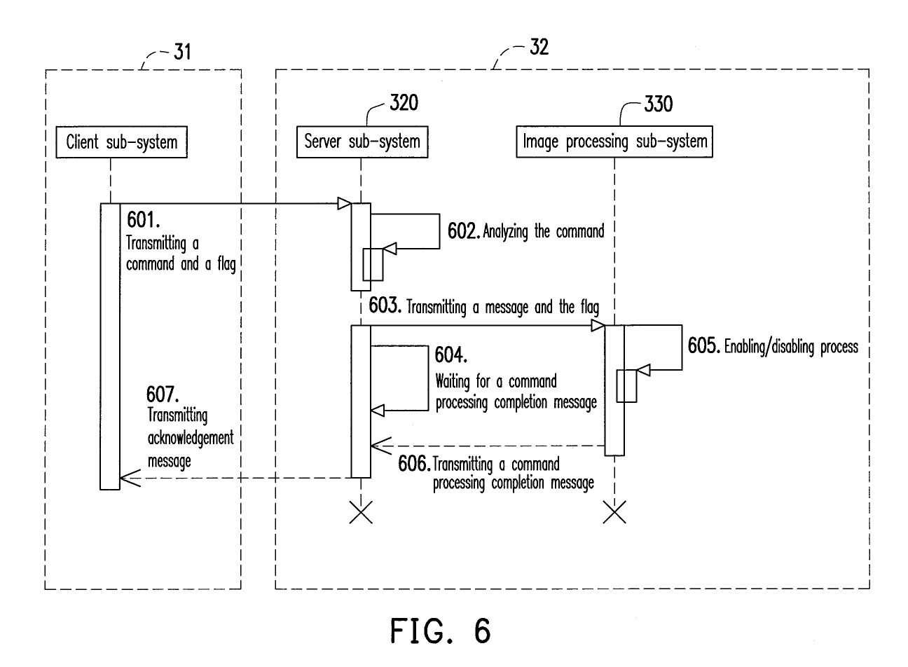

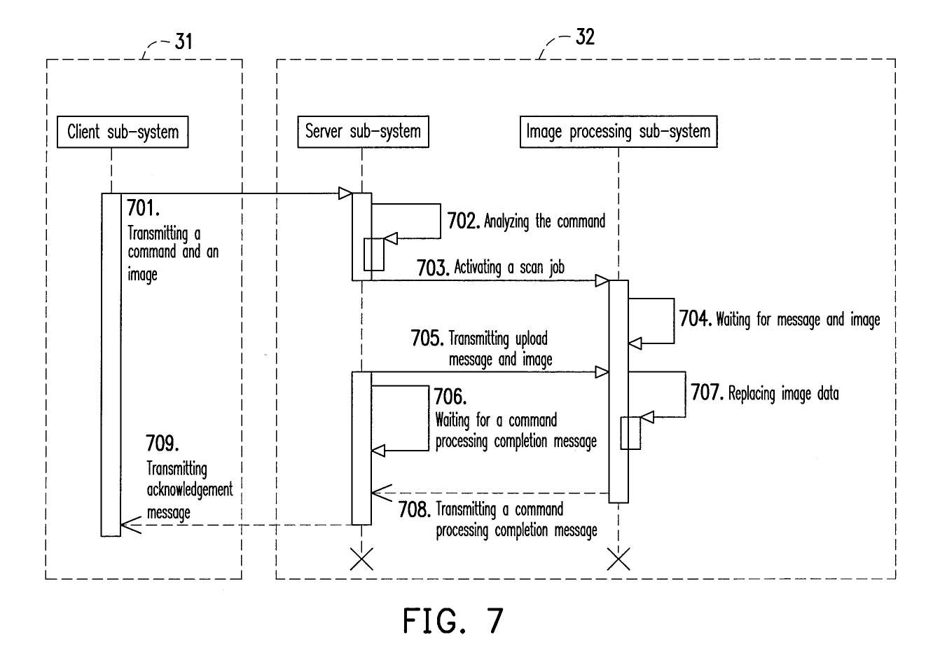

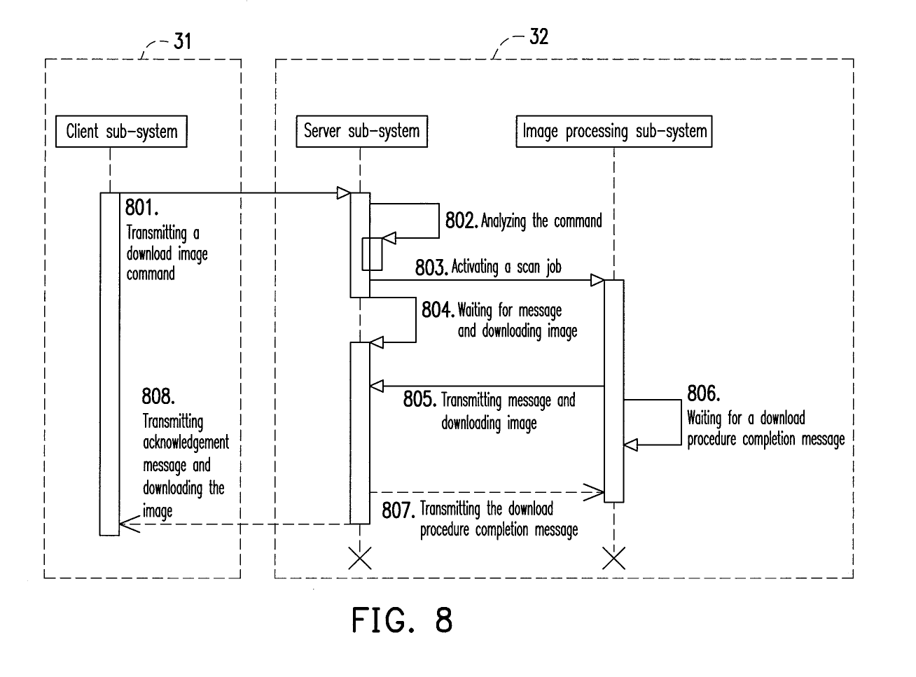

After the firmware end of the image processing device 32 receives a command, it performs corresponding operations according to the command. The command includes follow three main image processing functions. A first image processing function is to acquire/replace image quality parameters, and the first image processing function is described later with reference of FIG. 5. A second image processing function is to enable/disable an image processing process, and the second image processing function is described later with reference of FIG. 6. A third image processing function is to upload/download an image in any image processing process, and the third image processing function is described later in accordance with FIG. 7 and FIG. 8.

In step 404, the image processing process is executed. Taking a scanning job as an example, the image obtained after the scanning job generally includes image processing processes of a plurality of stages, and in the present exemplary embodiment, only the shading correction procedure and the gamma correction procedure are described, which are standard image processing procedures for image scanning, by which a standard tuned image can be obtained. When the scanning job is activated, the scanner of the image processing module 331 extracts data of a scanned document and converts it into digital data (step 404). Moreover, it is determined whether the shading correction procedure is executed according to a command (and parameters thereof) of the electronic device 31 (step 405). If a determination result of the step 405 is No, the flow continues to execute a next processing procedure (from a node E to a step 408), and if the determination result of the step 405 is Yes, the shading correction procedure is executed to compensate a shadow or uneven brightness caused by a light source to even the brightness (step 406).

The invention is not limited to the scanner, and in other embodiments, a printer, a digital camera, a projector or an AIO machine are also applicable, so that the corresponding step 404 includes executing a printing job, a digital video capturing job, a digital camera job or a projecting job.

Next, it is determined whether the gamma correction procedure is executed according to the command (and parameters thereof) of the electronic device 31 (step 408). If a determination result of the step 408 is negative, the flow is jumped to a next processing procedure (a step 411), and if the determination result of the step 408 is affirmative, the gamma correction procedure is executed to tune the image according to a correction curve thereof, so as to achieve a linear output effect (step 409). After each image processing function is performed, digital data processing is completed, and the test operator or the program designer can determine whether a required image quality effect is achieved according to an output image of the electronic device 31 (step 411). If the output effect is not satisfactory, the test operator or the program designer can use the electronic device 31 for another adjustment. That is, the step 403 is returned through a node D, and the image quality parameters of each image processing function are set again according to the parameter command, and the related steps 404 to 411 are executed again. Conversely, the image quality tuning process is terminated after the step 411.

In step 407, the test operator or the program designer can use the electronic device 31 to upload image data to replace an original scanning data during any image processing procedure by transmitting an upload image command. Moreover, taking the scanning job as an example, after the scanning job is activated, the operator or the program designer can use the electronic device 31 to transmit image data to the image processing device 32 to replace the original image data of a designated location, and the scanning job is continually executed till the completion. The designated location of the upload image is indicated as a node F in FIG. 4A and FIG. 4B, which is generally a procedure processing location in an image processing process or an image tuning procedure, which is, for example, a location where the image tuning procedure is completed by 50%.

In step 410, the test operator or the program designer can set the electronic device 31 to download an image from any image processing procedure location of the image processing device 32 to analyze the original scan data. That is, the electronic device 31 transmits a download image command to the image processing device 32. Taking the scanning job for an example, after the scanning job is activated, the image processing device 32 transmits the image data of the designated location to the electronic device 31, so as to facilitate the test operator or the program designer inspecting variation status of the image data at the designated location, where the currently executed scanning job is not influenced. The designated position for downloading the image is indicated as a node G in FIG. 4A and FIG. 4B, which is generally a procedure processing location in an image processing process or an image tuning procedure, which is, for example, a location where the image tuning procedure is completed by 80%.

According to the method for tuning image quality shown in FIG. 4A and FIG. 4B, image qualities of a plurality of AIO devices can be simultaneously adjusted. As long as IP addresses of the image processing devices are respectively set, in collaboration with network transmission or data cable transmission of the electronic device 31, firmware of the image processing devices are completely the same to that of the single image processing device without performing additional setting, so that the image quality of a plurality of the image processing devices can be simultaneously tuned.

The method for tuning image quality shown in FIG. 4A and FIG. 4B can be simplified as a processing process of FIG. 4C. FIG. 4C is a flowchart illustrating a method for tuning image quality according to another exemplary embodiment of the invention. Referring to FIG. 4C, the method for tuning image quality starts from a step 421. Firstly, the processor module 314 of the electronic device 31 executes compilation procedures of firmware of one or a plurality of image processing devices 32 (the step 421). Then, the processor module 314 performs burning procedures of the firmware of the one or a plurality of the image processing devices 32 through the connection with the server sub-system 320 (step 423).

Then, after the compilation procedures and the burning procedures are performed, the processor module 314 of the electronic device 31 receives commands and the corresponding parameters input by the operator or the program designer to respectively configure one or a plurality of image processing functions to the one or a plurality of the image processing devices, and respectively set image quality parameters of each of the image processing functions (step 425). In the step 425, the step of configuring the at least one image processing function includes respectively enabling or disabling each of the image processing functions. Moreover, the step of respectively setting image quality parameters of each of the image processing functions includes respectively setting or acquiring the image quality parameters of each of the image processing functions.

Moreover, the image processing module 331 of the image processing device 32 executes an image processing process including one or a plurality of image tuning procedures according to the acquired command and the corresponding quality parameters (step 427). In step 429, when the image processing module 331 executes each of the image tuning procedures, the test operator or the program designer can set the related parameters through the processor module 314 of the electronic device 31, so as to select to upload a predetermined image to a first predetermined image processing procedure location of the image tuning procedure currently executed by the image processing module 331, or select to download an image from a second predetermined image processing procedure location of the image tuning procedure currently executed by the image processing module 331. The image obtaining module 332 provides the downloaded image to the electronic deice 31. After the step 429, the method for tuning image quality is terminated.

Moreover, in an actual operation, after the electronic device 31 respectively executes the step 421 and the step 423 to the connected image processing devices 32 for only one time, the step 425, the step 427 and the step 429 can be performed to the connected image processing devices 32 for one time or multiple times. In other words, after the electronic device 31 performs the compilation procedure and the burning procedure to the connected image processing device 32 for just one time, it can repeatedly configure the image processing functions and the corresponding image quality parameters to the connected image processing device 32, execute the image processing process including the image tuning procedure, and select to upload the predetermined image to the first predetermined image processing procedure location of the currently executed image tuning procedure, or select to download an image from the second predetermined image processing procedure location of the currently executed image tuning procedure.

FIG. 5 is a flowchart illustrating a transmission flow of an acquire/replace quality parameter command according to an exemplary embodiment of the invention. Referring to FIG. 5, the transmission flow of the acquire/replace quality parameter command is started form a step 501. Firstly, the electronic device 31 located at a client sub-system transmits a command and image quality parameter data to the server sub-system 320 (the step 501). The server sub-system 320 receives the command from the client end, and confirms and analyzes the command (step 502). After the confirmation, the server sub-system 320 sends a message and the corresponding image quality parameters to the image processing sub-system 330 located at the device end to execute the acquire/replace quality parameter command (step 503), and then the server sub-system 320 waits for the image processing module 331 of the image processing sub-system 330 to transmit a command processing completion message after processing of the command is completed (step 504).

After the image processing module 331 receives the message, it sets or transmits back the parameter (step 505), and transmits a command processing completion message to the server sub-system 320 until the image processing module 331 completes processing the command (step 506). The server sub-system 320 receives the command processing completion message, and transmits acknowledgement (ACK) to the electronic device 31 at the client end to notify the electronic device 31 that it has received and processed the command sent by the electronic device 31 (step 507).

FIG. 6 is a flowchart illustrating a transmission flow of an enable/disable process command according to an exemplary embodiment of the invention. Referring to FIG. 6, the transmission flow of the enable/disable process command starts from a step 601. Firstly, the electronic device 31 at the client end transmits a command and a flag to the server sub-system 320 (step 601). The flag can be used for representing enabling or disabling of a processing procedure, which generally has one bit. The command indicates the processing procedure to be enabled or disabled. The server sub-system 320 receives the command from the electronic device 31, and confirms and analyzes the command (step 602), and after the confirmation, the server sub-system 320 sends a message and the flag to the image processing module 331 of the image processing sub-system 330 located at the device end to execute the enable/disable process command (step 603), and waits for the image processing module 331 to transmit a command processing completion message after completing processing the command (step 604).

After the image processing module 331 located at the device end receives the message, it enables or disables the image processing function (step 605), and transmits a command processing completion message to the server sub-system 320 until the image processing module 331 completes processing the command (step 606). The server sub-system 320 receives the command processing completion message, and transmits ACK to the electronic device 31 at the client end to notify the electronic device 31 that it has received and processed the command sent by the electronic device 31 (step 607). Moreover, the acquire/replace quality parameter command of FIG. 5 and the enable/disable process command of FIG. 6 all require execution of the step 403 of FIG. 4A.

FIG. 7 is a flowchart illustrating a transmission flow of an upload tuning image command according to an exemplary embodiment of the invention. Referring to FIG. 7, the transmission flow of the upload tuning image command starts from a step 701. In the step 701, the electronic device 31 at the client end transmits a command and image data to be set to the server sub-system 320. The command indicates an image processing procedure location of the image to be set. The server sub-system 320 receives the upload tuning image command from the electronic device 31, and confirms and analyzes the command (step 702), and after the confirmation, the server sub-system 320 activates the image processing process, and notifies the image processing module 331 of the image processing sub-system 330 located at the device end that the upload tuning image command is received, and the image processing module 331 immediately starts the image processing process (step 703).

Taking the scanning job as an example to describe the subsequent steps, when the image processing module 331 activates the scanning job and executes the scanning job to a designated (or predetermined) image processing procedure location of the image data to be set, the image processing module 331 pauses the image processing procedure, and waits for the message and the image data from the server sub-system 320 (step 704). The server sub-system 320 transmits the upload message and image data (step 705), and waits for the image processing module 331 to transmit a command processing completion message after completing processing the command (step 706).

After the image processing module 331 located at the device end receives the message from the server sub-system 320, it performs an operation of replacing the image data (step 707) until the image processing module 331 completes the scanning job and replacing the image data. In the present embodiment, the memory module 333 can be used to store the replaced image data of the designated image processing procedure location. Then, the image processing module 331 transmits back a command processing completion message to the server sub-system 320 (step 708). The server sub-system 320 receives the command processing completion message, and transmits ACK to the electronic device 31 at the client end to notify the electronic device 31 that it has received and processed the command sent by the client end (step 709).

FIG. 8 is a flowchart illustrating a transmission flow of a download image command according to an exemplary embodiment of the invention. Referring to FIG. 8, the transmission flow of the download image command starts from a step 801. Firstly, the electronic device 31 at the client end transmits the download image command to the server sub-system 320 (801). The server sub-system 320 receives the download image command from the electronic device 31, and confirms and analyzes the command (step 802), and after the confirmation, the server sub-system 320 notifies the image processing module 331 at the device end that the download image command is received, and the image processing module 331 immediately starts the image processing process (step 803).

Taking the scanning job as an example to describe the subsequent steps, and the server sub-system 320 starts to wait for the message and the downloaded image data from the image processing module 331 (step 804). When the image processing module 331 activates the scanning job and executes the scanning job to a designated image processing procedure location of the image data to be downloaded, the image processing module 331 transmits a message to the server sub-system 320 and starts to transmit the scanned image (step 805). In the present embodiment, the image obtaining module 332 can be used to obtain the image at the designated image processing procedure location.

After the image processing module 331 completes the scanning job, it waits for the server sub-system 320 to transmit a download procedure completion message (step 806). After the server sub-system 320 completes downloading the image data, it transmits the download procedure completion message to the image processing module 331 (step 807), and transmits ACK to the electronic device 31 at the client end to notify the electronic device 31 that it has processed the command sent by the electronic device 31 (step 709), and transmits the downloaded image data to the electronic device 31 (step 808).

The method for tuning image quality shown in FIG. 4A to FIG. 4C and the flows of various main functions shown in FIG. 5 to FIG. 8, can be used to substitute the existing image tuning method (tuning procedure) to achieve following effects. (1) In the method for tuning image quality of the invention, the program designer, test operator or image tuning engineer can dynamically adjust the image quality parameters, or even complete tuning images without having a programming background. (2) According to the method for tuning image quality of the invention, image quality of a plurality of image processing devices can be simultaneously tuned, so as to save a product development time and a rework time. (3) According to the method for tuning image quality of the invention, the quality parameter(s) of each of the image processing functions can be obtained and the corresponding image quality can be modified (including the manufactured image processing devices). (4) Remaking and rebuilding procedures are not necessary procedures for each image quality tuning process. That is, the image quality can be directed tuned without performing again the making and building procedures of the firmware. (5) According to the method for tuning image quality of the invention, the image can be loaded from a computer (i.e., image upload) or the image can be extracted from each of the image processing procedures (at the designated location) (i.e., image download). Therefore, even if the image processing device is suddenly power-off or the network connection is interrupted during the image quality tuning process, the previously downloaded images can still be saved at the computer end, so as to reduce rework times. (6) Even if the image quality of the manufactured image processing devices are required to be tuned, the image quality parameters thereof can be tuned through a network connection without sending the image processing devices to specific repair stations for tuning the image quality.

In summary, according to the method and image quality tuning system of the invention, by connecting the electronic device to one or a plurality of image processing devices, after the electronic device compiles and burns the firmware to the image processing devices, it can repeatedly acquire, replace or set the image quality parameters of various image processing devices. Moreover, a processing procedure location of a specific tuning process in the image processing process can be designated to upload an image to replace the image at the procedure location or download the image at the procedure location, so as to improve flexibility of the image quality parameter tuning process and improve efficiency for tuning the image quality.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for tuning image quality, adapted for tuning image quality parameters of at least one image processing device, and the method for tuning image quality comprising:
(a) executing a compiling procedure of firmware of the at least one image processing device;
(b) executing a burning procedure of the firmware of the at least one image processing device;
(c) configuring at least one image processing function to each of the image processing devices after the step (a) and the step (b) are executed, and respectively setting image quality parameters of each of the image processing functions;
(d) executing an image processing process, wherein the image processing process includes at least one image tuning procedure; and
(e) when each one of the image tuning procedures is executed, selecting to upload a predetermined image to a first predetermined image processing procedure location of the currently executed image tuning procedure, or selecting to download an image from a second predetermined image processing procedure location of the currently executed image tuning procedure.

2. The method for tuning image quality as claimed in claim 1, wherein the step of configuring the at least one image processing function comprises:
respectively enabling or disabling each of the image processing functions.

3. The method for tuning image quality as claimed in claim 2, wherein the step of respectively setting the image quality parameters of each of the image processing functions comprises:
respectively setting or acquiring the image quality parameters of each of the image processing functions.

4. The method for tuning image quality as claimed in claim 1, wherein the step of executing the image processing process comprises:
executing a scanning job, a printing job, a digital video capturing job, a digital camera job and a projecting job.

5. The method for tuning image quality as claimed in claim 1, wherein the at least one image tuning procedure comprises:
a shading correction procedure and a gamma correction procedure.

6. The method for tuning image quality as claimed in claim 1, wherein the step of selecting to upload the predetermined image to the first predetermined image processing procedure location of the currently executed image tuning procedure comprises:
uploading the predetermined image to the first predetermined image processing procedure location of the currently executed image tuning procedure to replace an image.

7. The method for tuning image quality as claimed in claim 1, wherein the at least one image processing device comprises a scanner, a printer, a digital camera and a projector.

8. The method for tuning image quality as claimed in claim 6, further comprising:
continually executing the image processing process after uploading the predetermined image to the first predetermined image processing procedure location to replace the image.

9. The method for tuning image quality as claimed in claim 1, wherein before the step (a), the method further comprises:
respectively connecting the image processing devices through a network or a data cable.

10. The method for tuning image quality as claimed in claim 9, wherein:
after respectively executing the step (a) and the step (b) to the connected image processing devices for just one time, the step (c), the step (d) and the step (e) are respectively executed to the connected image processing devices for at least one time.

11. A image quality tuning system, comprising:
an image processing device, configured for executing an image processing process, wherein the image processing device comprises a server sub-system and an image processing sub-system, wherein the image processing sub-system is configured for executing the image processing process, and a step of executing the image processing process comprises executing at least one image tuning procedure; and
an electronic device, configured for executing a compiling procedure and a burning procedure of firmware of the image processing device, wherein:
the electronic device is connected to the server sub-system through a network connection; and
after the electronic device executes the compiling procedure and the burning procedure for once, the electronic device performs following steps:
(a) configuring at least one image processing function to the image processing device for at least one time;
(b) respectively setting image quality parameters of each of the image processing functions and executing at least one image tuning procedure; and
(c) when each one of the image tuning procedures is executed, selecting to upload a predetermined image to a first predetermined image processing procedure location of the currently executed image tuning procedure, or selecting to download an image from a second predetermined image processing procedure location of the currently executed image tuning procedure.

12. The image quality tuning system as claimed in claim 11, wherein the server sub-system receives a first command for setting each of the image processing functions from the electronic device through the network, and enables or disables each of the image processing functions of the image processing sub-system according to each of the first commands.

13. The image quality tuning system as claimed in claim 12, wherein the server sub-system receives a second command for setting image quality parameters of each of the image processing functions from the electronic device through the network, and sets or acquires the image quality parameters of each of the image processing functions of the image processing sub-system according to each of the second commands.

14. The image quality tuning system as claimed in claim 11, wherein the step of executing the image processing process comprises:
executing a scanning job, a printing job, a digital video capturing job, a digital camera job and a projecting job.

15. The image quality tuning system as claimed in claim 11, wherein the at least one image tuning procedure comprises:
a shading correction procedure and a gamma correction procedure.

16. The image quality tuning system as claimed in claim 11, wherein the electronic device uploads the predetermined image to the first predetermined image processing procedure location of the image tuning procedure currently executed by the image processing sub-system through the server sub-system to replace an image.

17. The image quality tuning system as claimed in claim 11, wherein the electronic device downloads an image from a second predetermined image processing procedure location of the image tuning procedure currently executed by the image processing sub-system through the server sub-system.

18. The image quality tuning system as claimed in claim 11, wherein the at least one image processing device comprises a scanner, a printer, a digital camera and a projector.

19. The image quality tuning system as claimed in claim 16, wherein the image processing sub-system continually executes the image processing process after uploading the predetermined image to the first predetermined image processing procedure location to replace the image.

20. The image quality tuning system as claimed in claim 11, wherein the electronic device is connected to the image processing device through a network or a data cable.

21. The image quality tuning system as claimed in claim 20, wherein after the electronic device just executes the compiling procedure and the burning procedure for one time, it performs the step (a), the step (b) and the step (c) to the image processing device for at least one time through the server sub-system.
